(19) United States
(12) Patent Application Publication
(10) Pub. No.: US 2023/0202895 A1
(43) Pub. Date: Jun. 29, 2023

(54) CALCITE SCALE INHIBITORS FOR STRESSED PROCESS CONDITIONS

(71) Applicant: SOLENIS TECHNOLOGIES, L.P., Wilmington, DE (US)

(72) Inventors: Kirill N. Bakeev, Newark, DE (US); William S. Carey, Wallingford, PA (US); Derek Kline, Wilmington, DE (US); Aaron Lau, Lower Gwynedd, PA (US); Nick Morrison, Lebanon, OH (US)

(73) Assignee: SOLENIS TECHNOLOGIES, L.P., Wilmington, DE (US)

(21) Appl. No.: 18/069,295

(22) Filed: Dec. 21, 2022

Related U.S. Application Data
(60) Provisional application No. 63/265,949, filed on Dec. 23, 2021.

(51) Int. Cl. C02F 5/14

(52) U.S. Cl. CPC C02F 5/145; C02F 2303/08; C02F 2303/22

(57) ABSTRACT

A scale inhibitor composition for reducing calcium scale under stressed conditions is disclosed. The composition comprises an aqueous polymerization reaction product of an acrylic acid and a chain transfer agent, the reaction product comprising a low-molecular weight acrylic acid polymer having a weight averaged molecular weight (Mw) of from about 1,300 to about 15,000 Daltons. A method of preparing the scale inhibitor composition is also disclosed, and comprises reacting the acrylic acid and the chain transfer agent to give the reaction product comprising the acrylic acid polymer. A process for ameliorating calcite scale in a mining operation is further disclosed. The process comprises adding the scale inhibitor composition to process water comprising at least one stressed scaling condition.

### CROSS-REFERENCE TO RELATED APPLICATION

This application claims priority to and all benefits of U.S. Provisional Application No. 63/265,949, filed Dec. 23, 2021, the content of which is incorporated herein by reference.

### FIELD OF THE DISCLOSURE

The present disclosure relates generally to ameliorating scale in hydrometallurgical processes and, more specifically, to anti-scale compositions effective in stressed scaling conditions involving high pH, alkalinity, temperature, and/or calcium ion concentrations, such as those present in metal mining operations.

### BACKGROUND

Industrial operations involving aqueous systems are typically maintained via use of various chemicals to maintain throughput and reduce downtime associated with cleaning, scrubbing, and servicing or replacing parts due to detrimental effects inherent to the aqueous solutions being employed (e.g. scale formation, corrosion, etc.). For example, industrial operations involving downhole wells (e.g. for gas or oil production, geothermal wells, etc.), boiler water or steam generating systems, cooling water systems, desalination systems, among many others, rely on process water that is, or eventually becomes, contaminated with various metal cations (e.g. calcium, magnesium, barium, etc.) and inorganic anions (e.g. carbonate, sulfate, phosphate) inherent to the minerals in contact with process water. These contaminants readily form inorganic salts that are prone to precipitate and form hard deposits and scale due to low solubility, especially when exposed to outlying process conditions involving mineral concentrations, pH, temperatures, etc. Accordingly, various additives to solubilize, suspend, and/or disperse inorganic salts and salt-forming precursors are commonly utilized to minimize or prevent accumulation, deposition, and fouling associated with inorganic salts, as well as to treat insoluble deposits and scale formed therefrom. These additives can reduce the constant monitoring, cleaning, and maintenance of equipment necessary to maintain economical production volumes.

Unfortunately, however, conventional treatments are typically not suitable for use under “stressed” conditions involving relatively high pH, high alkalinity, high concentration of mineral ions, etc. which, among other challenges, exacerbate the solubility-related scaling and deposition issues described above. Under stressed conditions, the efficiency of conventional treatments drops significantly, rendering most traditional scale management solutions inoperable. Compounding this issue, certain additives such as corrosion inhibitors (e.g. orthophosphate and/or zinc compounds) increase the formation and/or deposition of some insoluble precipitates (e.g. calcium phosphate, zinc hydroxide, zinc phosphate) under stressed conditions. As such, some industrial operations that inherently involve stressed conditions, such as mining process operations involving the formation and/or concentration of mineral ore slurries, still require full operation shut down and manual cleanings to deal with scale and deposit accumulation. Such down time necessarily increases capital expenditure (CAPEX) and operational expenditures (OPEX), negatively limiting the production and economics of the associated products. Examples of such mining process operations, e.g. copper concentrator and flotation processes for copper production, gold heap leaching processes for gold production, etc., involve stressed scaling conditions including pH levels as high as 11.0-11.5 in combination with calcium ion concentrations in excess of 1000 ppm.

### BRIEF SUMMARY

A scale inhibitor composition (the “composition”) is provided. The composition is useful for reducing calcium scale, e.g. under stressed scaling conditions, and may be employed to prevent, minimize, maintain, reduce, or otherwise ameliorate calcium scale. The composition comprises, as an active agent, a reaction product of an acrylic acid and a chain transfer agent, the reaction product comprising a low-molecular weight acrylic acid polymer having a weight average molecular weight (Mw) of from about 1,300 to about 15,000 Daltons.

A method of preparing the scale inhibitor composition (the “method”) is also provided. The method comprises reacting the acrylic acid and the chain transfer agent, e.g. via aqueous-based solution polymerization, to give the reaction product comprising the acrylic acid polymer. The acrylic acid and the chain transfer agent may be reacted in the presence of a free radical initiator, and the method may further comprise adjusting the % solids and/or the pH of the reaction product comprising the acrylic acid polymer, to prepare the scale inhibitor composition.

A process for ameliorating calcite scale in a mining operation (the “process”) is further provided. The process comprises adding the scale inhibitor composition to a process water comprising at least one scaling condition selected from a pH of at least 11, a carbonate content of at least 220 ppm, a calcium ion content of at least 1200 ppm, both expressed as CaCO₃, a calcium saturation index of at least 500, and combinations thereof. The process water may comprise copper and/or gold, and the mining operation may be further defined as a copper concentrator and/or a flotation process for copper production or a gold heap leaching process for gold production.

### DETAILED DESCRIPTION

The following detailed description is merely exemplary in nature and is not intended to limit the instant composition or method. Furthermore, there is no intention to be bound by any theory presented in the preceding background or the following detailed description.

A scale inhibitor composition (the “composition”) is provided herein, along with a method for preparing composition (the “method”), as well as a process for ameliorating scale (e.g. calcite scale) in a mining operation with the composition (the “process”). As described in further detail below, the composition, method, and process utilize a low-molecular weight acrylic acid polymer, which is provided and used as an active component in the form of a reaction product of acrylic acid and a chain transfer agent. The particular details of the components, parameters, and steps underlying the composition, method, and process are described in the embodiments and examples provided herein. As will be appreciated in view of these embodiments and examples, the active agent and composition exhibits robust performance, which is greatly improved under stressed scaling conditions over conventional anti-scalants, and thus provides for an effective and economical solution to detrimental issues associated with scale amelioration in high-stress applications (e.g. mineral ore processing).

As will be appreciated by those of skill in the art in view of this disclosure, for the sake of brevity, conventional techniques related to the method, compositions, and process used therein may not be described in detail herein. Moreover, the various tasks and process steps described may be incorporated into a more comprehensive procedure or process having additional steps or functionality not described in detail herein. In particular, various steps in the manufacture of certain components utilized herein are well-known and, in the interest of brevity, such conventional steps may only be mentioned briefly or will be omitted entirely without providing well-known process details.

The scale inhibitor composition, as introduced above, comprises a low molecular weight acrylic acid polymer. In general, the acrylic acid polymer comprises the general formula R¹—[CH₂CH(CO₂R³)]a-R², where terminal groups R¹ and R² are each independently H or a moiety derived from a chain transfer agent, R³ is typically H, a metal cation, or a hydrocarbon group, and subscript a is at least 2.

The general formula of the acrylic acid polymer is given above for illustration. However, with regard to the repeating units of the polymer, as will be readily understood by those of skill in the art, each moiety indicated by subscript a is an acrylate-derived moiety, e.g. from radical polymerization of an acrylic acid, an acrylic ester, or a derivative thereof. For example, where R³ is H, the moiety indicated by subscript a may be described as an acrylic acid-derived moiety, e.g. formed by the radical polymerization of acrylic acid. However, it is to be understood that polymerization of an acrylic acid ester (e.g. methacrylate, to give R³ as —OCH₃) and subsequent hydrolysis can also give the acrylic acid polymer where R³ is H according to the general formula above. Nonetheless, the moiety may still be described and understood as an acrylic acid-derived monomeric unit in the context of the acrylic acid polymer. Likewise, it will be understood that any given R³, even when described as being H, is a generally labile group conventionally described in neutral form. In operation, a given R³ may be exchanged with a counter cation (e.g. a metal ion, such as Na, K, Mg, Ca, etc.), or the carboxyl group may be deprotonated (e.g. when in a basic environment) to exist as the carboxylate anion. Such instances are included within the description of the acrylic acid polymer.

In some embodiments, the acrylic acid polymer may be a copolymer of acrylic acid and one or more other monomers, and thus may comprise an additional segment corresponding to the incorporation of such other monomers in the polymer chain. These embodiments would not be fully described by the verbatim general formula given above; however one of skill in the art will appreciate that another repeating unit (e.g. derived from an ethylenically unsaturated monomer, such as an acrylic ester, an (alkyl)acrylic acid, acrylamide, 2-acrylamido-2-methylpropane sulfonic acid, styrene, ethylene, etc.) can be incorporated into the acrylic acid polymer.

With regard to the acrylic acid polymer as a whole, R¹ and R² are typically each H, with individual molecules of the polymer comprising the derivative of a chain transfer agent utilized in preparing the polymer, in proportion to the amount of the chain transfer agent utilized. For example, as described below, the acrylic acid polymer may be prepared via the method utilizing 10 mol % of the chain transfer agent, on the basis of the moles of acrylic acid utilized in the polymerization reaction. In such instances, the proportion of R¹ and R² being derived from the chain transfer agent will be higher than another acrylic acid polymer, of the same degree of polymerization (i.e., as indicated by subscript a) prepared via the method utilizing less than 10 mol % of the chain transfer agent.

In some embodiments, at least one of R¹ and R² comprises a thioether moiety (e.g. of formula —S—R⁴), or an ether moiety (e.g. of formula —O—R⁴), where each R⁴ is independently a substituted or unsubstituted hydrocarbon group (e.g. an alkyl group, hydroxyalkyl group, aminoalkyl group, etc.), and R⁵ is H or R⁴. As will be appreciated by those of skill in the art, such moieties may arise from preparing the acrylic acid polymer with a chain transfer agent comprising a thiol group (e.g. a thio compound), an alcohol group (e.g. an alcohol compound, or simply an “alcohol”). In these or other embodiments, at least one of R¹ and R² comprises an alkanol moiety, e.g. of formula —R⁶—OH where R⁶ is a hydrocarbon linking group. For example, in some such embodiments, the alkanol moiety is formed from isopropanol and comprises the formula —C(CH₃)₂—OH. It will be appreciated that in various embodiments, a mixture of different R1 and/or R2 groups may be realized, as such when a chain transfer agent may form more than one end group. For example, when isopropanol is utilized, the resulting end groups may independently be the ether moiety (e.g. —O—CH(CH₃)₂) or the alkanol moiety (e.g. —C(CH₃)₂—OH) as described above.

It is to be appreciated that a given R¹ or R² may comprise, or be, a moiety derived from a catalyst, carrier (e.g. solvent), or adjuvant utilized in the preparation of the acrylic acid polymer. However, such instances will generally be limited in number and, on average, will not constitute a major proportion of the terminal groups of the acrylic acid polymer.

The degree of polymerization, degree of substitution, and identity of the particular substituent R¹, R², and/or R³ can be determined by conventional methods known by those of skill in the art, such as via spectroscopic methods (e.g. NMR, IR, GC/MS) as well as chromatographic methods (i.e., compared to known standards/reference materials), including those provided for in the examples herein.

Typically, the acrylic acid polymer has a relatively-low molecular weight, e.g. a weight averaged molecular weight (Mw) of from about 1,300 to about 15,000 Daltons. For example, in some embodiments, the acrylic acid polymer has a Mw of from about 1,300 to about 10,000, alternatively of from about 1,300 to about 6,000, alternatively of from about 1,300 to about 3,000 Daltons. In these or other embodiments, the acrylic acid polymer has a relatively-low number averaged molecular weight (Mn), e.g. a Mn of from about 1,300 to about 15,000 Daltons. In specific embodiments, the acrylic acid polymer has a Mn of from about 1,300 to about 10,000, alternatively of from about 1,300 to about 6,000, alternatively of from about 1,300 to about 3,000 Daltons. The Mw and Mn, and thus the PDI, of the acrylic acid polymer can be determined by conventional means known in the art. For example, the acrylic acid polymer may be analyzed via size exclusion chromatography (SEC) and/or gel permeation chromatography (GPC), e.g. relative to standards comprising polyacrylic polymers of known and narrow molecular weight distributions, to determine molecular weight.

As introduced above, the acrylic acid polymer is a reaction product of an acrylic acid and a chain transfer agent. As such, it will be appreciated by those of skill in the art that the description of the acrylic acid polymer above and the method below are integrally related, such that the acrylic acid polymer may be described and/or characterized in terms of its actual structure, on the basis of the components utilized to prepare the acrylic acid polymer, or both. Moreover, in terms of the composition, it is to be appreciated that the acrylic acid polymer may be utilized directly in an as-prepared form, i.e., as the reaction product prepared without further processing and/or purification, or in a purified and/or altered form. For example, the composition may be formulated by simply preparing the acrylic acid polymer (e.g. via the method, as described below) as a crude reaction product, performing minimal processing of the crude reaction product (e.g. solvent exchange, concentration, filtration, etc.), and subsequently combining the resulting processed acrylic acid polymer with other components of the composition to give the scale inhibitor composition. Alternatively, the acrylic acid polymer may be highly purified prior to incorporation into the composition. The specific level of post-synthesis processing prior to preparing the composition with the acrylic acid polymer may vary, and will typically depend on the parameters and results of the method, the desired end use, the level of specificity desired for using the composition (e.g. in terms of active concentration, overall dosing, etc.). For example, in some embodiments, the acrylic acid polymer is prepared in the form of the reaction product, which is then simply neutralized and/or diluted to adjust the pH and/or solids content of the reaction product thereof prior to incorporation into, or use as, the composition. These embodiments will be better understood in view of the description of the embodiments of the method below, and the exampled provided herein.

In some embodiments, the composition has a total solids content (“% total solids”) of from about 15 to about 70%, alternatively from about 35 to about 70%. For example, in specific embodiments, the composition comprises a % total solids of from about 30 to about 65%. In particular embodiments, the composition comprises a % total solids of from about 39 to about 55%. In other embodiments, the composition comprises a % total solids of from about 55 to about 64, alternatively from about 55 to about 61%. In yet other embodiments, the composition comprises a % total solids of from about 53 to about 62%. The final % total solids of the composition may be selected based on the performance of the particular acrylic acid polymer utilized therein, as will be understood in view of the example provided herein. The % total solids of the composition may be determined via thermogravimetric analysis, as also demonstrated in the examples herein.

In general, the composition typically comprises a pH of from about 2 to about 12.5. In some embodiments, the composition comprises a pH of from about 2 to about 10. In specific embodiments, the composition comprises a pH of from about 4 to about 6, such as from about 4.5 to about 6, alternatively of from about 4.5 to about 5.2, alternatively of from about 4.8 to about 5.2, alternatively of from about 4.8 to about 5.1. In other embodiments, the composition comprises a pH of from about 4 to about 5, such as from about 4.5 to about 5, alternatively of from about 4.6 to about 4.9. The pH of the composition may be altered via conventional methods, e.g. via use of an acid or base to adjust the pH down or up, accordingly. It will be appreciated based on the description of the acrylic acid polymer that altering the pH of the composition may be utilized to alter the functionality of the acrylic acid polymer therein, e.g. via increasing or decreasing the protonation state of the acid functional groups thereon.

In addition to the acrylic acid polymer, the composition may comprise one or more additional components. These additional components may be functional (i.e., provide a desired chemical reactivity/function to the composition) or may be simply included to formulate the composition in a desired fashion. For example, the composition may comprise a carrier vehicle, which may itself comprise one or more solvents, dispersants, etc. Typically, the composition comprises water. However, it is to be appreciated that it is possible to prepare and use composition free from water, alternatively substantially free from water (e.g. <5 wt. %, <2.5 wt. %, or <1 wt. % water, based on the total weight of the composition), alternatively essentially free from water.

In some embodiments, the composition comprises a water-miscible or water-soluble organic solvent, such as a liquid alcohol, etc. For example, in specific embodiments, the composition comprises a C1-C6 alcohol, such as a methanol, ethanol, propanol, butanol, pentanol, hexanol, phenol, or combination thereof. In some such embodiments, the composition comprises an organic solvent selected from the group of ethanol, isopropanol, dodecanol, and combinations thereof. In specific such embodiments, the composition comprises isopropanol.

In some embodiments, the composition comprises an additional scale inhibitor, a corrosion inhibitor, a dispersant, or combinations thereof.

Examples of additional scale inhibitors generally include organic and inorganic phosphonates, organophosphonates, polyphosphates, organic chelants, polymeric chelants, and various combinations thereof. For example, in some embodiments, the composition comprises one or more additional scale inhibitors selected from strong acids (e.g. phosphonic acids, phosphoric acids, phosphorous acids, phosphonate/phosphonic acids, etc.), aminopolycarboxylic acids, chelating agents, polymeric scale inhibitors (e.g. polymaleic acid), as well as salts thereof.

In specific embodiments, the composition comprises an additional scale inhibitor comprising an inorganic phosphate having the formula (I):

Yₙ₊₂PₙO₃ₙ₊₁ (I),

where Y is Na, K, H, or combinations thereof, and n is an integer having a value of at least 6.

With regard to inorganic phosphates of formula (I), Y is typically Na, and the integer n of has a value of at least 2, alternatively at least 6, alternatively at least 8, alternatively at least 9, alternatively at least 10, alternatively at lease 11, alternatively at least 12, or alternatively at least 21. In some embodiments, the integer n of formula (I) may have a value of from 2 to 30, alternatively from 6 to 30, alternatively from 8 to 30, or alternatively from 10 to 30.

Examples of inorganic phosphates of formula (I) suitable for use in or as the additional scale inhibitor include sodium hexametaphosphate (Na₈P₆O₁₉), sodium heptaphosphate (Na₉P₇O₂₂), sodium octaphosphate (Na₁₀P₈O₂₅), sodium nonaphosphate (Na₁₁P₉O₂₈), sodium decaphosphate (Na₁₂P₁₀O₃₁), sodium hendecaphosphate (Na₁₃P₁₁O₃₄), and sodium dodecaphosphate (Na₁₄P₁₂O₃₇), and sodium henicosphosphate (Na₂₃P₂₁O₆₄). In certain embodiments, the inorganic phosphate of formula (I) includes sodium dodecaphosphate, where n of formula (I) is an integer having a value of 12. In other embodiments, the inorganic phosphate of formula (I) includes sodium henicosphosphate, where n is an integer having a value of 21. Additional examples of inorganic phosphates include tetrasodium pyrophosphate (Na₄P₂O₇) (“TSPP”), sodium triphosphate (Na₅P₃O₁₀) (“STPP”), sodium trimetaphosphate (NaPO₃)₃ (“STMP”), and combinations thereof.

In some embodiments, the composition comprises an additional scale inhibitor comprising an organic phosphonate. Examples of suitable organic phosphonates include 2-phosphonobutane-1,2,4-tricarboxylic acid (“PBTC”), 1-hydroxyethane 1,1-diphosphonic acid (“HEDP”), bis(phosphonomethyl)aminotris(methylenephosphonic acid) (“ATMP”), bis(hexamethylene triamine penta (methylene phosphonic acid)) (“BHMTPMPA”), hexamethylenediaminetetra (methylene phosphonic acid) (“HMDTMPA”), diethylene tri amine pentamethylene phosphonic acid (“DETPMPA”), and the like, as well as combinations thereof.

In some embodiments, the composition comprises one or more additional scale inhibitors selected from polymeric scale inhibitors, such as polycarboxylic aids, salts of acrylamido-methyl propane sulfonate/acrylic acid copolymer (AMPS/AA), polymaleic acid, phosphinated maleic copolymer (PHOS/MA), salts of acrylic acid/t-butylacrylamide/acrylamido-methyl propane sulfonate terpolymers (AA/tBAM/AMPS), polyaspartic acids, and the like, as well as combinations thereof.

In some embodiments, the composition comprises one or more additional scale inhibitors selected from chelants (i.e., chelating compounds). Example of suitable chelating compounds include ethylenediaminetetraacetic acid (EDTA), diethylenetriaminepentaacetic acid (DTPA), nitrilotriacetic acid (NTA), ethylenediaminetetramethylene-phosphonic acid (EDTMP), diethylene triaminepentamethylenephosphonic acid (DTPMP), nitrilotrimethylenephosphonic acid (NTMP), aminopolycarboxylic acids (APCAs), gluconates, citrates, and the like, as well as combinations thereof.

In specific embodiments, the composition comprises at least one, alternatively at least two, of the additional scale inhibitors described herein. In some such embodiments, the additional scale inhibitor is combined with the acrylic acid polymer in a synergistic amount providing improved scale inhibition compared to compositions free from the acrylic acid polymer.

As introduced above, a method for preparing the scale inhibitor composition is also provided. In general, the method comprises reacting acrylic acid and a chain transfer agent to give a reaction product comprising the acrylic acid polymer, as described above. More specifically, the method utilizes a polymerization reaction (e.g. radical polymerization) to prepare the acrylic acid polymer from the acrylic acid in the presence of the chain transfer agent, thereby preparing the acrylic acid polymer having a controlled structure as described above.

The reaction of the acrylic acid and the chain transfer agent is typically carried out via aqueous solution-state radical polymerization utilizing a radical initiator, as described below. As such, the reaction may be carried out in the presence of water and/or water-compatible carrier vehicles, such as the solvents described herein. For example, in some embodiments, the reaction is carried out in an aqueous solvent system comprising water and at least one alcohol (e.g. isopropanol). In other embodiments, the acrylic acid and/or the chain transfer agent itself is used as a carrier for one or more components of the reaction

The chain transfer agent is not particularly limited, although specific agents are demonstrated herein to provide surprising and superior results in terms of the performance of the resulting acrylic acid polymer in high-stress scaling conditions, as described below.

In general, the chain transfer agent is defined in the conventional sense as known to those of skill in the art in the context of the present disclosure, i.e., a substance able to react with a chain carrier during the chain polymerization of the acrylic acid, thereby functioning to deactivate the original chain carrier and generative a new chain carrier for subsequent propagation. In this fashion, the active center of the growing polymer chain is transferred between molecular sites, resulting in a controlled reduction in the Mw of the resulting polymer. Utilizing the particular components and parameters described herein, the acrylic acid polymer is typically prepared with a Mw of from about 1,300 to about 15,000 Daltons as set forth above. It will be appreciated that alternative names may be given to chain transfer agents without departing from the scope of the term as used herein. For example, the terms “modifiers” and “regulators” are used in the polymer arts to refer to compounds that demonstrate similar and/or equivalent functions as chain transfer agents. In the context of the present disclosure, a compound which effectuates a controlled reduction in the molecular weight and/or molecular weight distribution of the acrylic acid polymer prepared may be functionally considered a chain transfer agent as the term is used herein.

In certain embodiments, the chain transfer agent comprises, alternatively is, a thio compound, a phospho compound, an alcohol, or a combination thereof.

Examples of thio compounds generally include chain transfer agents with a sulfur atom capable of reacting with an active center of the acrylic acid polymer during the polymerization thereof. General examples thus include thiols, small organic molecules with sulfhydryl, sulfanyl, or mercapto groups, disulfide compounds, inorganic sulfur compounds comprising sulfite groups, as well as precursors or derivatives thereof (e.g. compounds that degrade, react, or rearrange to give such functional groups during the reaction). Specific examples of such thio compounds include mercaptocarboxylic acids, alkanethiols, sulfites, and combinations thereof. In some embodiments, the chain transfer agent comprises, 3-mercaptoproprionic acid, 2-mercaptoethanol, 2-mercaptoacetic acid, 1-dodecanethiol, sodium metabisulfite, and the like, as well as derivatives, modifications, precursors, and combinations thereof. In this fashion, examples of “like” compounds include, for example, potassium metabisulfite, which may also be utilized. In specific embodiments, the chain transfer agent comprises sodium metabisulfite, 2-mercaptoacetic acid, 3-mercaptoproprionic acid, or a combination thereof.

Examples of phosphorous compounds generally include chain transfer agents with a phosphorous atom in a functional group. General examples thus include hypophosphorous acids, sodium hypophosphites, and the like, as well as combinations thereof. In specific embodiments, the chain transfer agent comprises hypophosphorous acid.

Examples of alcohol compounds generally include organic compounds comprising an alcohol or hydroxy functional group. General examples thus include any of the thiol compounds described herein where the thiol group may instead be an alcohol group. For example, C1-C18 linear or branched alcanols may be utilized. In specific embodiments, for example, the chain transfer agent comprises isopropanol.

The chain transfer agent may be employed in various amounts, which will typically be selected based on the reactivity of the chain transfer agent, a desired property of the acrylic acid polymer being prepared, etc. For example, in general, the chain transfer agent is utilized in amount of from about 0.4 to about 15 mol %, alternatively from about 0.6 to about 12 mol %, based on the total amount (moles) of acrylic acid being polymerized. In some embodiments, the chain transfer agent is utilized in amount of from about 0.5 to about 5 mol %, alternatively from about 0.5 to about 1 mol %, based on the total amount (moles) of acrylic acid being polymerized. In other embodiments, the chain transfer agent is utilized in amount of from about 4 to about 12 mol %, alternatively from about 4 to about 10 mol %, alternatively from about 4 to about 9 mol %, alternatively from about 4 to about 8 mol %, based on the total amount (moles) of acrylic acid being polymerized. In yet other embodiments, the chain transfer agent is utilized in amount of from about 5 to about 12 mol %, alternatively from about 6 to about 11 mol %, alternatively from about 7 to about 10 mol %, based on the total amount (moles) of acrylic acid being polymerized. The particular amount of the chain transfer agent utilized can be selected in order to decrease the molecular weight of the resulting acrylic acid polymer, based on the specific parameters of the polymerization reaction employed.

The polymerization reaction of the method may be carried out in the presence of a catalyst and/or initiator. Typically, a radical initiator is employed. Examples of radical initiators generally include compounds capable of generating a free radical that can promote the polymerization of the acrylic acid, under the conditions utilized in the polymerization reaction. general examples radical initiators include organic and inorganic peroxides (i.e., peroxy compounds), azo compounds, persulfates, and compounds with nitrogen-halogen bonds. In some embodiments, the acrylic acid and the chain transfer agent are combined with a free radical initiator comprising a peroxy compound, a persulfate, an azonitrile compound, or a mixture thereof. Specific examples of suitable initiators include sulfites, such as sodium sulfite, sodium bisulfite, and the like, persulfates, etc., as well as derivatives, modifications, precursors, and combinations thereof. In this fashion, examples of “like” compounds include, for example, potassium persulfate and ammonium persulfate, which may also be utilized. In specific embodiments, the method comprises polymerizing the acrylic acid in the presence of a potassium or sodium persulfate as initiators and/or sodium bisulfite as an initiator, optionally combined with sodium metabisulfite as the chain transfer agent.

Once the reaction product comprising the acrylic acid polymer is prepared, the reaction product itself may be utilized directly in, or as the scale inhibitor composition, or alternatively, the method may further comprise processing the reaction product in some fashion before utilizing it in, or as, the composition. For example, in some embodiments, the reaction product is combined with a carrier vehicle (e.g. water) to achieve a desired % solids level, combined with an acid or base to achieve a desired pH, or both. Once adjusted, the processed reaction product may be utilized as the scale inhibitor composition, or may be combined with the one or more additional components described above to give the scale inhibitor composition.

As introduced above, a process for ameliorating calcite scale in a mining operation is also provided. In general, the process comprises adding the scale inhibitor composition to mining process water at any point directly preceding the onset of scaling or, alternatively, just at the scaling point. For example, in some embodiments the process comprises adding the scale inhibitor composition directly to fresh water, recirculated process water, combined water streams, or various combinations thereof.

In the context of the present disclosure, the term “ameliorating” is used to encompass all positively-influencing actions taken with regard to unwanted scale in the operation being treated. In this sense, the process may be carried out to prevent, minimize, maintain, reduce, or eliminate the formation, deposition, and/or presence of scale within the process water the composition is added to. It will be understood that parameters associated with the addition of the composition to the process water may be tailors to achieve a desired end result, i.e., where an earlier introduction of the composition along the process line may result in more effective prevention of scale formation, whereas a later addition may be selective employed to clean scaled surfaces.

The process water generally comprises a mineral selected from gold, aluminum, silver, platinum, copper, nickel, zinc, lead, molybdenum, cobalt, and combinations thereof. The process water may further comprise additional components, such as quartz, dolomite, calcite, gypsum, barite or muscovite, and the like, or various combinations thereof. In some embodiments, the process water comprises a process stream in a copper mine or concentrator operation (e.g. mill water). In other embodiments, the process water comprises a process stream of a gold heap leaching operation (e.g. irrigation stream, leachant, etc.). Such copper mills/concentrators, and gold heap leaching operations, typically comprise process streams under stressed scaling conditions.

Typically, the solids content of the process water, that is the amount of mineral content in the slurry, is at least about 8%, at least about 10%, at least about 20%, at least about 30%. For example, process water may have a solids content of about 8% to about 30%, including about 10% to about 20%, such as about 10% to about 15%. Persons of ordinary skill in these arts, after reading this disclosure, will appreciate that all ranges and values for the solids content of the process water are contemplated.

Typically, the process is carried out under a “stressed” scaling condition (i.e., a condition conducive to the ready formation of scale, e.g. calcite scale. For example, in some embodiments, the composition is added to the process water having a pH of at least 10, alternative at least 10.5, alternatively at least 11, alternatively at least 11.5. In these or other embodiments, the composition is added to process water having a carbonate content of at least 200, alternatively at least 210, alternatively at least 220, alternatively at least 230, alternatively at least 240 ppm, e.g. as CaCO₃. In these or other embodiments, the composition is added to process water having a calcium ion content of at least 1000, alternatively at least 1200, alternatively at least 1300, alternatively at least 1400, alternatively at least 1500, alternatively at least 1600, alternatively at least 1700, alternatively at least 1800 ppm, e.g. as CaCO₃. In these or other embodiments, the composition is added to the process water having a calcium saturation index of at least 500, alternatively at least 600, alternatively at least 700, alternatively at least 800, alternatively at least 900, alternatively at least 1000. In these or other embodiments, the composition is added to process water at a temperature of from 10 to 50, alternatively from 5 to 45, alternatively from 5 to 45, alternatively from 5 to 45, alternatively from 15 to 45, alternatively from 15 to 40, alternatively from 15 to 35, alternatively from 15 to 30, alternatively from 20 to 30, ° C.

The scale inhibitor composition is effective at relatively low-loading doses, such as when the active concentration of the reaction product, or the acrylic acid polymer, in process water is from 2 to 12 ppm, such as from 4 to 7, alternatively from 5 to 7, alternatively of about 6, ppm. As such, in typical embodiments, the process comprises adding an amount of the composition to process water sufficient to provide an aqueous phase concentration of the acrylic acid polymer of from 4 to 8, alternatively from 4 to 7, alternatively from 5 to 7, alternatively of about 6, ppm.

The description above is merely exemplary in nature and is not intended to limit the composition, method, or process provided. Furthermore, there is no intention to be bound by any theory presented in the background or the detailed description, which is also included for example and context in view of the embodiments described herein.

### EXAMPLES

Characterization & Analysis Procedures

The following procedures and equipment are utilized to characterize and analyze the samples prepared in the Examples further below.

Turbidity Test Protocol: 10 oz Jars with stir bars are placed on a 10-spot magnetic stirrer plate; blank and up to 8 products are run in duplicates using 2 identical stirrer plates. Calcium solution (100 mL) using CaCl₂) stock (6.862 g CaCl₂*2H₂O/2 L) is dispensed, and a desired dosage of scale inhibitor sample based on 200 mL system is added. Alkalinity solution (100 mL) based on Na₂CO₃ stock (0.953 g Na₂CO₃/2 L), with adjusted pH (50/50 NaOH, 316 μL) to reach the target (e.g. pH: 11.2; T: 21.0° C.; 1168 ppm Ca (as CaCO₃); 225 ppm CO₃ (as CaCO₃); 103 ppm Na; 828 ppm Cl), is dispensed, and jars are mixed on low speed for 30 minutes prior to recording turbidity. Temperature is measured in the jars to ensure overall temperature control. Turbidity sensor (Synaptic) is calibrated using a 100 NTU standard and DI water (0 NTU). Each jar is then sampled for turbidity measurements, with values based on the following formula:

$$\% Turbidity Inhibition = \frac{Blank NTU - Product NTU}{Blank NTU} \times 100 \% .$$

Thermogravimetric Analysis (TGA): Approximately 30 mg of sample was placed in a platinum TGA pan. The sample was tested using the TA Instruments TGA Q50 under nitrogen according to the following method: 10° C./min ramp rate from room temperature to 105° C., then held at 105° C. for 3 hours. The total solids percentage is determined by subtracting the weight before and after analysis.

Size-Exclusion Chromatography (SEC): The instrument (Alliance 2695) is calibrated using polyacrylic acid standards with narrow molecular weight distribution in 0.1M NaNO₃/20% acetonitrile. The sample solutions are filtered through 0.45 μm PVDF filter and travel through the column (TSKgel GMPWxl 13 μm; 30° C. or 40° C.). The flow rate through the column is 0.8 mL/min, and the refractive index detector signal was used for processing the data. The data gathered from the size exclusion chromatography is then used to determine molecular weight and molecular weight distribution of the samples.

### Synthesis Example Sets 1-4: Scale Inhibitor Compositions

A reactor equipped with an overhead stirrer, multiple addition points, heating, water cooled exchanger and a thermometer was charged with water. The reactor system is configured to be under a nitrogen blanket and the temperature was adjusted to 90±2° C. Once the desired temperature is achieved a simultaneous staggard co-feed of acrylic acid monomer (AA), sodium persulfate initiator solution (SPS, typically 20-25 wt. % in water), and chain transfer agent (CTA) is initiated. The feed times for the reagents in the examples is summarized in Table 1 below. The SPS charge is typically 0.6-0.7 mole % relative to the AA charge. The polymerization solids is typically 50-60 wt. %. After the reagent feeds are completed the batch is held at temperature for 1-hour, then cooled to room temperature. During the cool down additional water and/or 50% caustic is optionally charged to adjust the weight % solids and/or pH of the final product (scale inhibitor compositions).

All products are analyzed according to the procedures set forth above. For each product, AA conversion levels of 99+% are achieved. The parameters of Example Sets 1-4 are set forth in Table 1 below. Performance results of the scale inhibitor compositions of Example Sets 1-4 are set forth in Table 2 further below.

### Synthesis Example Set 5: Scale Inhibitor Compositions

A reactor set-up as described in the synthesis of Example Sets 1-4 above is equipped with a distillation head configured for reflux conditions. Water and the CTA (isopropyl alcohol (IPA)) are charged to the reactor. Under a nitrogen blanket the reactor contents are then heated to 78±2° C. Once the desired temperature is achieved a simultaneous staggard co-feed of the AA and SPS is initiated. The polymerization solids in these reactions is 45 wt. %, and the SPS charge is 0.7 mole % relative to the AA charge. After the reagent feeds are complete the reactor is configured for distillation conditions and the batch temperature adjusted to 98±2° C. During the heat-up residual IPA is stripped from the batch as an azeotrope with water while simultaneously charging additional water to the reactor to yield a final product of the desired wt. % solids. After the strip is completed, the batch is cooled to room temperature and the pH adjusted with 50% caustic to give the final product (scale inhibitor compositions).

All products are analyzed according to the procedures set forth above. For each product, AA conversion levels of 99+% were achieved. The parameters of Example Set 5 are set forth in Table 1 below. Performance results of the scale inhibitor compositions of Example Set 5 are set forth in Table 2 further below.

TABLE 1
Example Sets 1-5: Synthesis Parameters of Acrylic Acid Polymers

| | | CTA | CTA | AA | SPS | | |
|---|---|---|---|---|---|---|---|
| Example | CTA | Mole % | mins. | mins. | mins. | Mw | PDI |
| 1a | 2-MAA | 3.36 | 200 | 210 | 255 | 10,156 | 3.19 |
| 1b | 2-MAA | 5.60 | | | | 5,364 | 2.60 |
| 1c | 2-MAA | 7.84 | | | | 3,128 | 1.99 |
| 2a | 3-MPA | 4.48 | 200 | 210 | 255 | 5,411 | 2.26 |
| 2b | 3-MPA | 5.60 | | | | 3,887 | 3.20 |
| 2c | 3-MPA | 7.84 | | | | 3,128 | 1.98 |
| 2d | 3-MPA | 8.96 | | | | 1,662 | 3.93 |
| 3a | Hypo | 4.00 | 195 | 210 | 240 | 15,886 | 3.52 |
| 3b | Hypo | 6.00 | | | | 11,011 | 3.17 |
| 3c | Hypo | 8.00 | | | | 5,813 | 5.45 |
| 4a | SMBS | 4.00 | 210 | 210 | 240 | 10,488 | 3.79 |
| 4b | SMBS | 6.00 | | | | 2,813 | 4.58 |
| 4c^{a} | SMBS | 8.00 | | | | 2424^{a} | 2.27^{a} |
| 5a | IPA | 33.00 | N/A | 180 | 210 | 22,733 | 4.30 |
| 5b | IPA | 66.00 | | | | 9,859 | 3.00 |

^{a}values reported are average results from 22 independent samples prepared according to the same procedure.

In Table 1, the following abbreviations used are as follows:

CTA: chain transfer agent

CTA Mole %: amount CTA used, on the basis relative to the acrylic acid charge

AA: acrylic acid;

SPS: sodium persulfate (initiator)

2-MAA: 2-mercaptoacetic acid

3-MPA: 3-mercaptopropionic acid

Hypo: hypophosphorous acid

SMBS: sodium metabisulfite

IPA: isopropyl alcohol

### Example Set 6: Blended Scale Inhibitor Compositions

Example 6a: 28.8 parts by weight of the acrylic acid polymer prepared as described above in Example 2b (˜44.5 wt. % solids, pH ˜6.5) is blended with 21.35 parts Additional Scale Inhibitor 1 (bis(hexamethylene-triamine)penta(methylenephosphonic acid)), further diluted with 39 parts water, and pH adjusted with 10.8 parts 50% caustic. The percent inhibition (Turbidity Test Protocol) at 6 ppm was 57%.

Example 6b: 11.88 parts by weight a acrylic acid polymer prepared the same as described above in Example 2b (˜44.5 wt. % solids, pH ˜6.5) was blended with 10.69 parts of Additional Scale Inhibitor 2 (polymaleic acid) and 22.50 parts Additional Scale Inhibitor 3 (diethylenetriaminepenta-(methylenephosphonic acid)), further diluted with 38.39 parts water, and pH adjusted with 16.49 parts 50% caustic.

The products of Example Set 6 are analyzed according to the procedures above, with performance results set forth in Table 2 below.

TABLE 2
Characteristics & Performance of Scale Inhibitor Compositions
of Example Sets 1-6 and Comparative Examples 1-3

| Example | Solids (wt. %) | pH | Inhibition @ 6 ppm (%) |
|---|---|---|---|
| 1a | 59 | 5.08 | 58 |
| 1b | 62 | 4.90 | 65 |
| 1c | 62 | 4.77 | 70 |
| 2a | 59 | 4.80 | 61 |
| 2b | 55 | 4.90 | 68 |
| 2c | 56 | 4.80 | 69 |
| 2d | 55 | 4.86 | 78 |
| 3a | 60 | 5.09 | 56 |
| 3b | 59 | 4.97 | 62 |
| 3c | 58 | 4.79 | 62 |
| 4a | 45 | 7.45 | 58 |
| 4b | 43 | 7.35 | 61 |
| 4c | 53 | 3.68 | 95 |
| 5a | 44 | 4.11 | 68 |
| 5b | 41 | 4.14 | 64 |
| 6a | 28 | 5.00 | 57 |
| 6b | 27 | 4.5 | 62 |

### Comparative Examples

Conventional scale inhibitors were obtained from commercial sources and used without further modification in the procedures above to give Comparative Examples 1-3. Specifically, Comparative Example 1 is a sulfonated copolymer (carboxylate/sulfonate/non-ionic functional), which exhibits a % inhibition at 6 ppm of 63.5%. Comparative Example 2 is a maleic acid polymer (polymaleic acid), which exhibits a % inhibition at 6 ppm of 52.2%. Comparative Example 3 is a poly isopropenyl phosphate, which exhibits a % inhibition at 6 ppm of 28.75%.

As demonstrated by the examples, the scale inhibitor composition of the present embodiments exhibits improved inhibition performance, with a general increase in inhibition observed from compositions prepared using increased amount of CTA agent The scale inhibiting efficacy is believed to depend on the nature of the CTA utilized in the reaction, allowing for performance attributes of the composition to be tailored to different level of stress conditions in mining process water applications. In comparison to conventional polyacrylate products with lower amount of CTA, higher levels of incorporation of certain types of CTAs (SMBS, 3-MPA) make polyacrylates most effective in scale inhibition.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims. Moreover, all combinations of the aforementioned components, compositions, method steps, formulation steps, etc. are hereby expressly contemplated for use herein in various non-limiting embodiments even if such combinations are not expressly described in the same or similar paragraphs.

With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the ranges and subranges enumerated herein sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. An individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

Lastly, it will be understood that the term “about” with regard to any of the particular numbers and ranges described herein is used to designate values within standard error, equivalent function, efficacy, final loading, etc., as understood by those of skill in the art with relevant conventional techniques and processes for formulation and/or utilizing compounds and compositions such as those described herein. As such, the term “about” may designate a value within 10, alternatively within 5, alternatively within 1, alternatively within 0.5, alternatively within 0.1, % of the enumerated value or range.

While the present disclosure has been described with respect to particular embodiments thereof, it is apparent that numerous other forms and modifications will be obvious to those skilled in the art. The appended claims and this disclosure generally should be construed to cover all such obvious forms and modifications, which are within the true scope of the present disclosure.

1. A scale inhibitor composition for reducing calcium scale under stressed scaling conditions, comprising:
an aqueous polymerization reaction product of an acrylic acid and a chain transfer agent, the reaction product comprising a acrylic acid polymer having a weight averaged molecular weight (Mw) of from about 1,300 to about 15,000 Daltons.

2. The scale inhibitor composition of claim 1, wherein the chain transfer agent comprises: (i) a thio compound; (ii) a phospho compound; (iii) an alcohol; or (iv) any combination of (i)-(iii).

3. The scale inhibitor composition of claim 1, wherein the chain transfer agent comprises a thio compound chosen from mercaptocarboxylic acids, alcanethiols, and combinations thereof.

4. The scale inhibitor composition of claim 3, wherein the thio compound comprises 3-mercaptopropionic acid, 2-mercaptoacetic acid, 2-mercaptoethanol, 1-dodecanethiol, sodium sulfite, sodium metabisulfite, sodium persulfate, potassium persulfate, and/or ammonium persulfate.

5. The scale inhibitor composition of claim 1, wherein the chain transfer agent comprises a phosphorous compound chosen from hypophosphorous acids, sodium hypophosphites, and combinations thereof.

6. The scale inhibitor composition of claim 1, wherein the chain transfer agent comprises a C₁-C₁₈ linear or branched alkanol.

7. The scale inhibitor composition of claim 1, wherein the acrylic acid polymer comprises a weight average molecular weight (Mw) of from about 1,300 to about 10,000, alternatively of from about 1,300 to about 6,000, alternatively of from about 1,300 to about 3,000 Daltons.

8. The scale inhibitor composition of claim 1, further comprising an additional scale inhibitor, a corrosion inhibitor, a dispersant, or combinations thereof.

9. The scale inhibitor composition of claim 1, wherein the scale inhibitor composition comprises an additional scale inhibitor chosen from organic phosphonates, inorganic polyphosphates, organic chelants, polymeric chelants, and combinations thereof.

10. The scale inhibitor composition of claim 9, wherein the additional scale inhibitor comprises:
(i) an inorganic phosphate having the general formula Yₙ₊₂PnO₃ₙ₊₁, where Y is Na, K, H, or combinations thereof, and n is an integer having a value of at least 6;
(ii) an organic phosphonate comprising 2-phosphonobutane-1,2,4-tricarboxylic acid, 1-hydroxyethane 1,1-diphosphonic acid, bis(phosphonomethyl)aminotris(methylenephosphonic acid), bis(hexamethylene triamine penta (methylene phosphonic acid)), hexamethylenediaminetetra (methylene phosphonic acid), diethylene triamine pentamethylene phosphonic acid, or a combination thereof; or
(iii) both (i) and (ii).

11. A method of preparing the scale inhibitor composition of claim 1, said method comprising:
reacting the acrylic acid and the chain transfer agent via aqueous solution polymerization to give a reaction product comprising the acrylic acid polymer, thereby preparing the scale inhibitor composition.

12. The method of claim 11, wherein the acrylic acid and the chain transfer agent are reacted in the presence of a free radical initiator.

13. The method of claim 12, wherein the free radical initiator comprises a peroxy compound, a persulfate compound, an azonitrile compound, or a combination thereof.

14. The method of claim 12, wherein the free radical initiator comprises potassium or sodium persulfate, ammonium persulfate, sodium bisulfite, or a combination thereof.

15. The method of claim 11, further comprising adjusting the % solids and/or the pH of the reaction product comprising the acrylic acid polymer.

16. A process for ameliorating calcite scale in a mining operation, comprising:
adding the scale inhibitor composition of claim 1 to a process water comprising at least one scaling condition selected from: (i) a pH of at least 11; (ii) a carbonate content of at least 200 ppm expressed as CaCO₃; (iii) a calcium ion content of at least 1000 ppm expressed as CaCO₃; (iv) a calcium saturation index of at least 500; or (v) any combination of (i)-(iv).

17. The process of claim 16, wherein the scale inhibitor composition is added to the process water in an amount sufficient to provide an aqueous phase concentration of the acrylic acid polymer of from 2 to 12 ppm.

18. The process of claim 16, wherein the process water comprises a mineral chosen from gold, aluminum, silver, platinum, copper, nickel, zinc, lead, molybdenum, cobalt, and combinations thereof.

19. The process of claim 16 wherein the mining operation is further defined as copper concentrating for copper production or gold heap leaching for gold production.
